(19) United States
(12) Patent Application Publication
(10) Pub. No.: US 2023/0106532 A1
(43) Pub. Date: Apr. 6, 2023

(54) COLD-STABLE NCO PREPOLYMERS, METHOD FOR THE PREPARATION AND USE THEREOF

(71) Applicant: Covestro Deutschland AG, Leverkusen (DE)

(72) Inventors: Jakob Marbach, Leverkusen (DE); Christos Karafilidis, Leverkusen (DE); Martin Marazita, Langenfeld (DE); Marc Schumacher, Bergheim (DE); Hans-Detlef Arntz, Overath (DE)

(21) Appl. No.: 17/909,899

(22) PCT Filed: Mar. 31, 2021
(86) PCT No.: PCT/EP2021/058409

§ 371 Date: Sep. 7, 2022

(30) Foreign Application Priority Data
Apr. 7, 2020 (EP) 20168601.1

(51) Int. Cl. C08G 18/12; C08G 18/48; C08G 18/30

(52) U.S. Cl. CPC C08G 18/12; C08G 18/4825; C08G 18/307; C08G 2170/00; C08G 2101/00

(57) ABSTRACT

A cold-stable NCO-containing prepolymer obtainable from the reaction of an isocyanate-reactive component comprising polyether carbonate polyols having an isocyanate component comprising methylene diphenyl diisocyanate (MDI) with high contents of 4,4′-MDI, a method for the preparation thereof, and the use thereof in one- or two-component systems for foams, elastomers, adhesives and sealants provided.

### CROSS REFERENCE TO RELATED APPLICATIONS

This application is a U.S. national stage application, filed under 35 U.S.C. § 371, of International Application No. PCT/EP2021/058409, which was filed on Mar. 31, 2021, which claims priority to European Patent Application No. 20168601.1, which was filed on Apr. 7, 2020. The contents of each are hereby incorporated by reference into this specification.

### FIELD

The present invention relates to cold-stable NCO-containing prepolymers obtainable from the reaction of an isocyanate-reactive component comprising polyether carbonate polyols with an isocyanate component comprising methylenediphenyl diisocyanate (MDI) having high contents of 4,4′-MDI, to a process for preparation thereof and to the use thereof in 1- and 2-component systems for foams, elastomers, adhesives and sealants.

### BACKGROUND

NCO-containing prepolymers are used in many technical fields, in particular for the preparation of foams and elastomers, for adhesive bonding and coating of substrates and in sealants. Both moisture-curable 1-component systems and also 2-component systems are used, wherein polyols and/or polyamines are often employed as coreactants for the NCO-containing prepolymers.

If elastomers are to be prepared from NCO-containing prepolymers, 4,4′-MDI is often employed. At room temperature 4,4′-MDI is a solid which has a propensity for irreversible formation of dimers. In this case irreversible is to be understood as meaning that the dimers do not undergo cleavage under the processing conditions and impair product properties Similar characteristics are also observed in prepolymers based on 4,4′-MDI. These NCO-containing prepolymers must therefore be temperature controlled during storage and cannot be employed without temperature control, for example at low outside temperatures on construction sites.

Attempts are often made to use mixtures of 4,4′-MDI and 2,4′-MDI to improve the crystallization propensity, i.e. to lower the crystallization temperature and thus increase cold stability. The reduced reactivity of the ortho NCO groups in 2,4′-MDI is disadvantageous here. It is therefore of interest to prevent crystallization of 4,4′-MDI-containing prepolymers to ensure processing and storage even at low temperatures.

U.S. Pat. Nos. 4,115,429 and 4,118,411 disclose cold-stable NCO-containing prepolymers which are prepared using polyether polyols as the isocyanate-reactive component and diphenylmethane diisocyanates having a 2,4′-MDI content of at least 20% by weight or 15% by weight as the polyisocyanate component. A disadvantage of such prepolymers is the reduced reactivity compared to prepolymers having high 4,4′-MDI contents.

NCO-containing prepolymers comprising polyether carbonate polyols as synthesis components are described in EP 2 566 906 B1 and EP 2 691 434 B1 for example. The NCO-containing prepolymers described therein are prepared using diphenylmethane diisocyanates (MDI) having a functionality of much greater than 2 and are therefore not suitable for preparing elastomers. High contents of isomers (i.e. 2,4′- or 2,2′-MDI) and higher homologs (so-called polynuclear MDI or polymer MDI) of 4,4′-MDI are used. The applications are silent about the cold stability of the prepolymers.

EP 0 292 772 B1 also discloses NCO prepolymers containing polyether carbonate polyols, wherein the polyether units of the polyether carbonate polyols are based primarily on hexanediol and other diols having at least five carbon atoms. The use of polyether units with two or three carbon atoms is expressly discouraged, since the high hydrophilicity and/or pendant substituents would adversely affect the performance characteristics of the polyurethane products formed.

DE 10 2012 218 848 A1 discloses the two-stage preparation of thermoplastic polyurethane elastomer. In a first reaction, a polyether carbonate polyol reacts with diphenylmethane diisocyanate to afford an NCO prepolymer, wherein this NCO prepolymer is not isolated but rather converted into a thermoplastic polyurethane elastomer with a chain extender after a reaction time of just 60 s. The problem of cold stability does not arise in such a two-stage process in which the NCO prepolymer is not stored but rather reacted in situ.

US 2015/0344751 A1 discloses NCO prepolymers of polyether carbonate polyols and diphenylmethane diisocyanate, wherein a mixture of 2,4′-MDI and 4,4′-MDI is used as the MDI and an NCO prepolymer having a low NCO content, and thus a high viscosity and in turn a low cold stability, is obtained. The cold stability of the NCO prepolymers is not addressed.

US 2012/095122 A1 discloses NCO prepolymers of polyether carbonate polyols and 4,4′-diphenylmethane diisocyanate but does not address the problem of cold stability. Neither the specific CO₂ content of the polyether carbonate polyols, nor the specific NCO content of the NCO prepolymers, is disclosed.

### SUMMARY

The problem addressed by the present invention was that of preparing cold-stable NCO prepolymers based on 4,4′-MDI to be able to utilize the elevated reactivity thereof compared to prepolymers based on other MDI isomers, even at low temperatures, thus making it possible to use the NCO prepolymer without a heating step or storage at higher temperatures.

This problem is surprisingly solved by the cold-stable NCO prepolymers according to the invention.

The present invention provides a cold-stable NCO prepolymer obtainable from the reaction of
A) an isocyanate-reactive component comprising at least one polyether carbonate polyol obtainable from the reaction of a starter molecule with CO₂ and an alkylene oxide selected from the group consisting of ethylene oxide, propylene oxide and mixtures thereof with
B) an isocyanate component comprising methylenediphenyl diisocyanate comprising a proportion of 4,4′-methylenediphenyl diisocyanate of at least 95% by weight based on the total amount of methylenediphenyl diisocyanate, in particular

wherein the NCO prepolymer has an NCO content of 9-18% by weight determined as indicated in the description and/or

wherein the polyether carbonate polyol has a CO₂ content of 5-25% by weight determined as specified in the description and/or

wherein the polyether carbonate polyol comprises monomer units deriving from the CO₂ and from the alkylene oxide and at least 50%, respectively, of the monomer units deriving from the CO₂ and of the monomer units deriving from the alkylene oxide have a random distribution in the polyether carbonate polyol.

### DETAILED DESCRIPTION

What is concerned therefore is an NCO prepolymer obtainable by reacting an isocyanate-reactive component A) with an isocyanate component B), wherein A) comprises at least one polyether carbonate polyol whose polyether segments comprise two, three or sometimes two and sometimes three carbon atoms and wherein B) comprises methylenediphenyl diisocyanate comprising a proportion of 4,4′-MDI of at least 95% by weight, in particular wherein the NCO prepolymer has an NCO content of 9-18% by weight determined as specified in the description and/or in particular wherein the polyether carbonate polyol has a CO₂ content of 5-25% by weight determined as specified in the description and/or in particular wherein the polyether carbonate polyol comprises monomer units (“polyether segments”) deriving from the CO₂ and from the alkylene oxide and at least 50%, respectively, of the monomer units deriving from the CO₂ and of the monomer units deriving from the alkylene oxide have a random distribution in the polyether carbonate polyol.

In the context of the present application cold-stable is to be understood as meaning that the the prepolymer according to the invention containing polyether carbonate polyols exhibits crystallization/precipitation only at a temperature which is lower, preferably at least 2.5° C. lower, more preferably at least 5.0° C. lower, yet more preferably at least 7.5° C. lower, than the temperature at which a conventional prepolymer containing a polyether polyol corresponding to the polyether carbonate polyol undergoes crystallization or precipitation. Corresponding in this case is to be understood as meaning that the functionalities and OH numbers (OHN, hydroxyl number, determined based on DIN 53240-2 as described in the examples) are comparable.

In the context of the present application the NCO content describes the weight fraction of NCO groups based on the total weight of a substance, for example of the NCO prepolymer. It is determined as specified in the examples section.

In the context of the present application the CO₂ content describes the weight fraction of carbonate groups based on the total weight of a substance, for example of the polyether carbonate polyol. It is determined as specified in the examples section.

In one embodiment the isocyanate component B) comprises methylenediphenyl diisocyanate which comprises a proportion of 4,4′-MDI of 95-100% by weight, preferably at least 97% by weight or 97-100% by weight, in each case based on the total amount of the methylenediphenyl diisocyanate.

In one embodiment the isocyanate component B) consists of the methylenediphenyl diisocyanate which comprises a proportion of 4,4′-MDI of at least 95% by weight, preferably 95-100% by weight, more preferably at least 97% by weight or 97-100% by weight.

In one embodiment the isocyanate-reactive component A) comprises a proportion of the at least one polyether carbonate polyol of at least 60% by weight, preferably at least 75% by weight, more preferably at least 85% by weight, in each case based on the total isocyanate-reactive component A).

In a further embodiment the NCO prepolymer has an NCO content of 5-31% by weight, preferably of 7-25% by weight, more preferably of 9-18% by weight, determined as specified in the description.

In one embodiment the isocyanate-reactive component consists of the at least one polyether carbonate polyol.

In a preferred embodiment the polyether carbonate polyol has a CO₂ content of 5-25% by weight, preferably of 7-22% by weight, particularly preferably of 9-21% by weight, determined as specified in the description.

In a particularly preferred embodiment at least 75%, respectively, more preferably at least 85%, respectively, most preferably at least 95%, respectively, of the monomer units deriving from the CO₂ and of the monomer units deriving from the alkylene oxide have a random distribution in the polyether carbonate polyol.

In a further preferred embodiment the polyether carbonate polyol has an OHN determined as specified in the description of 24-250 mg KOH/g.

The preparation of polyether carbonate polyols is known per se to those skilled in the art. They are preferably prepared by addition of one or more alkylene oxides and carbon dioxide onto one or more

H-functional starter substances (“copolymerization”) in the presence of at least one double metal cyanide (DMC) catalyst. According to the invention the alkylene oxide is ethylene oxide, propylene oxide or mixtures thereof. The polyether carbonate polyols preferably have an OH functionality of 1-8, particularly preferably of 2-6 and very particularly preferably of 2-4. The molecular weight is preferably 400-10 000 g/mol and particularly preferably 500-6000 g/mol.

The process for preparing polyether carbonate polyols is for example characterized in that it comprises

(α) initially charging an H-functional starter substance or a mixture of at least two H-functional starter substances and optionally removing water and/or other volatile compounds by means of elevated temperature and/or reduced pressure (“drying”), wherein the DMC catalyst is added to the H-functional starter substance or to the mixture of at least two H-functional starter substances before or after drying,

(β) adding a portion (based on the total amount of alkylene oxides used in the activation and copolymerization) of one or more alkylene oxides to the mixture resulting from step (a) to achieve activation, wherein this portion of alkylene oxide may optionally be added in the presence of CO₂ and wherein the temperature spike (“hotspot”) which occurs due to the exothermic chemical reaction that follows and/or a pressure drop in the reactor is then awaited in each case, and wherein step (β) for activation may also be carried out repeatedly,

(γ) adding one or more alkylene oxides and carbon dioxide to the mixture resulting from step (β), wherein the alkylene oxides used in step (γ) may be identical or different to the alkylene oxides used in step (β).

In the context of the present invention activation is to be understood as meaning a step in which a portion of alkylene oxide compound is added to the DMC catalyst, optionally in the presence of CO₂, and then the addition of the alkylene oxide compound is interrupted and a temperature spike (“hotspot”) and/or a pressure drop in the reactor is observed on account of an exothermic chemical reaction which follows. The process step of activation is the period from addition of the portion of alkylene oxide compound, optionally in the presence of CO₂, to the DMC catalyst until occurrence of the hotspot. The activation step may generally be preceded by a step for drying the DMC catalyst and optionally the starter by means of elevated temperature and/or reduced pressure, wherein this step of drying is not part of the activation step in the context of the presently described process.

Suitable H-functional starter substances that may be employed are compounds having alkoxylation-active H atoms. Alkoxylation-active groups having active H atoms are, for example, —OH, —NH₂ (primary amines), —NH— (secondary amines), —SH and —CO₂H, preferably —OH and —NH₂, particularly preferably —OH. H-functional starter substances employed include, for example, one or more compounds selected from the group consisting of mono- or polyhydric alcohols, polyfunctional amines, polyhydric thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines (for example the products called Jeffamines® from Huntsman, for example D-230, D-400, D-2000, T-403, T-3000, T-5000 or corresponding BASF products, for example Polyetheramine D230, D400, D200, T403, T5000), polytetrahydrofurans (e.g. PolyTHF® from BASF, for example PolyTHF® 250, 650S, 1000, 10005, 1400, 1800, 2000), polytetrahydrofuranamines (BASF product Polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and C1-C24-alkyl fatty acid esters containing an average of at least 2 OH groups per molecule. The C1-C24 alkyl fatty acid esters containing an average of at least 2 OH groups per molecule are for example commercial products such as Lupranol Balance® (from BASF AG), Merginol® products (from Hobum Oleochemicals GmbH), Sovermol® products (from Cognis Deutschland GmbH & Co. KG) and Soyol®TM products (from USSC Co.).

Monofunctional starter compounds that may be employed include alcohols, amines, thiols, and carboxylic acids. Monofunctional alcohols that may be used include: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, tert-butylamine, pentylamine, hexylamine, aniline, aziridine, pyrrolidine, piperidine, morpholine. Monofunctional thiols that may be employed include: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances include for example dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and also all products of modification of these abovementioned alcohols having different amounts of ε-caprolactone.

The H-functional starter substances may also be selected from the substance class of the polyether polyols, in particular those having a molecular weight Mn in the range from 100 to 4000 g/mol. Preference is given to polyether polyols formed from repeating ethylene oxide and propylene oxide units, preferably comprising a proportion of propylene oxide units of 35% to 100%, particularly preferably comprising a proportion of propylene oxide units of 50% to 100%. These may be random copolymers, gradient copolymers, alternating copolymers or block copolymers of ethylene oxide and propylene oxide. Suitable polyether polyols formed from repeating propylene oxide and/or ethylene oxide units are for example the Desmophen®, Acclaim®, Arcol®, Baycoll®, Bayfill®, Bayflex®, Baygal®, PET® and polyether polyols from Covestro Deutschland AG (for example Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are, for example, the Pluriol® E products from BASF SE, suitable homopolypropylene oxides are, for example, the Pluriol® P products from BASF SE; suitable mixed copolymers of ethylene oxide and propylene oxide are, for example, the Pluronic® PE or Pluriol® RPE products from BASF SE.

The H-functional starter substances may also be selected from the substance class of the polyester polyols, in particular those having a molecular weight Mn in the range from 200 to 4500 g/mol. Polyester polyols employed are at least difunctional polyesters. Polyester polyols preferably consist of alternating acid and alcohol units. Acid components employed include, for example, succinic acid, maleic acid, maleic anhydride, glutaric acid, adipic acid, pimelic acid, suberic acid, sebacic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components employed include, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Using dihydric or polyhydric polyether polyols as the alcohol component affords polyesterether polyols which may likewise be used as starter substances for preparation of the polyether carbonate polyols. It is preferable to use polyether polyols having Mₙ=150 to 2000 g/mol for preparation of the polyesterether polyols.

In addition, H-functional starter substances used may be polycarbonate diols, especially those having a molecular weight Mn in the range from 150 to 4500 g/mol, preferably 500 to 2500, which are prepared, for example, by reaction of phosgene, dimethyl carbonate, diethyl carbonate or diphenyl carbonate and difunctional alcohols or polyester polyols or polyether polyols. Examples of polycarbonates may be found, for example, in EP-A 1359177. For example, the Desmophen® C products from Covestro Deutschland AG, for example Desmophen® C 1100 or Desmophen® C 2200, may be used as polycarbonate diols.

In a further embodiment of the invention polyether carbonate polyols may be used as H-functional starter substances. In particular, polyether carbonate polyols obtainable by the process according to the invention described here are used. To this end these polyether carbonate polyols used as H-functional starter substances are prepared beforehand in a separate reaction step.

The H-functional starter substances generally have a functionality (i.e. number of hydrogen atoms active for the polymerization per molecule) of 1 to 8, preferably of 2 or 3. The H-functional starter substances are used either individually or as a mixture of at least two H-functional starter substances.

Preferred H-functional starter substances are alcohols of general formula (II),

HO—(CH₂)ₓ—OH (II)

wherein x is a number from 1 to 20, preferably an even number from 2 to 20. Examples of alcohols of formula (II) are ethylene glycol, propane-1,3-diol, butane-1,4-diol, hexane-1,6-diol, octane-1,8-diol, decane-1,10-diol and dodecane-1,12-diol. Further preferred H-functional starter substances are neopentyl glycol, trimethylolpropane, glycerol, pentaerythritol, reaction products of the alcohols of formula (II) with ε-caprolactone, e.g. reaction products of trimethylolpropane with ε-caprolactone, reaction products of glycerol with ε-caprolactone, and reaction products of pentaerythritol with ε-caprolactone. Preferably employed H-functional starter substances further include water, propane-1,2-diol, diethylene glycol, dipropylene glycol, castor oil, sorbitol and polyether polyols formed from repeating polyalkylene oxide units.

The H-functional starter substances are particularly preferably one or more compounds selected from the group consisting of ethylene glycol, propane-1,2-diol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, di- and trifunctional polyether polyols, where the polyether polyol has been formed from a di- or tri-H-functional starter substance and propylene oxide or a di- or tri-H-functional starter substance, propylene oxide and ethylene oxide. The polyether polyols preferably have a molecular weight Mn in the range from 62 to 4500 g/mol and a functionality of 2 to 3, and especially a molecular weight Mn in the range from 62 to 3000 g/mol and a functionality of 2 to 3.

H-functional starter substances having a functionality of 2 are very particularly preferred.

In addition to the polyether carbonate polyol the isocyanate-reactive component A) may comprise further isocyanate-reactive compounds, for example polyether polyols, polyester polyols, polyether ester polyols, polycarbonate polyols or further polyether carbonate polyols. These may each be the same compounds that are described in the preceding paragraphs as possible H-functional starter substances for the polyether carbonate polyol present in the NCO prepolymer according to the invention, preferably compounds having two isocyanate-reactive groups, for example two hydroxyl groups.

It is thus preferable when all compounds comprising the isocyanate-reactive component comprise two isocyanate-reactive groups.

The invention further provides a process for preparing a cold-stable NCO prepolymer according to the invention, in particular wherein the NCO prepolymer has an NCO content of 9-18% by weight determined as specified in the description, comprising the steps of
i) providing an isocyanate-reactive component A) comprising at least one polyether carbonate polyol obtainable from the reaction of a starter molecule with CO₂ and an alkylene oxide selected from the group consisting of ethylene oxide, propylene oxide and mixtures thereof, wherein the polyether carbonate polyol in particular has a CO₂ content of 5-25% by weight determined as specified in the description, and an isocyanate component B) comprising methylenediphenyl diisocyanate comprising a proportion of 4,4′-methylenediphenyl diisocyanate of at least 95% by weight based on the total amount of methylenediphenyl diisocyanate,
ii) mixing components A) and B) to obtain a mixture,
iii) reacting the mixture obtained in step ii) to obtain the cold-stable NCO prepolymer, in particular

wherein the polyether carbonate polyol has a CO₂ content of 5-25% by weight determined as specified in the description and/or

wherein the polyether carbonate polyol comprises monomer units deriving from the CO₂ and from the alkylene oxide and at least 50%, respectively, of the monomer units deriving from the CO₂ and of the monomer units deriving from the alkylene oxide have a random distribution in the polyether carbonate polyol.

It is preferable when the components A) and B) are reacted by methods known per se to those skilled in the art. For example the isocyanate component and the isocyanate-reactive component may be mixed at a temperature of 20-80° C. to form the NCO-containing prepolymer. The reaction is generally complete after 30 minutes to 24 hours to form the NCO-containing prepolymer. Activators known to those skilled in the art may optionally be used to prepare the NCO-containing prepolymer.

The invention further provides for the use of a cold-stable NCO prepolymer according to the invention for preparing a polyurethane elastomer, foam, adhesive or sealant.

The preparation of such polyurethane elastomers, foams, adhesives or sealants is known per se to those skilled in the art and is described, for example, in WO 02/46259 A1, EP 0 292 772 B1, EP 2 691 434 B1 and DE 10 2009 058 463 A1.

The invention additionally provides a polyurethane elastomer, foam, adhesive or sealant obtainable from the reaction of a cold-stable NCO prepolymer according to the invention with an isocyanate-reactive compound.

Preference is given to the polyurethane elastomer, foam, adhesive or sealant obtainable from the reaction of a cold-stable NCO prepolymer according to the invention and a carbodiimide-containing 4,4′-methylenediphenyl diisocyanate having an NCO content of 26-33% by weight with an isocyanate-reactive compound, for example wherein the carbodiimide-containing 4,4′-methylenediphenyl diisocyanate is Desmodur® CD-S.

In one embodiment this isocyanate-reactive compound is water from an environment of the cold-stable NCO prepolymer, preferably wherein the environment is a gas atmosphere surrounding the cold-stable NCO prepolymer or a substrate on which the cold-stable NCO prepolymer is present.

The present invention will be further elucidated with reference to the following examples.

### EXAMPLES

Substances used:
Polyol 1: Polyether carbonate polyol having an OH number of 56 mg KOH/g and a CO₂ content of 14% by weight prepared in the presence of a DMC catalyst by addition of propylene oxide and carbon dioxide using propane-1,2-diol as a starter.
Polyol 2 Polyether carbonate polyol having an OH number of 112 mg KOH/g and a CO₂ content of 14% by weight, prepared in the presence of a DMC catalyst by addition of propylene oxide and carbon dioxide using propane-1,2-diol as a starter.
Polyol 3 Polyether polyol having an OH number of 56 mg KOH/g prepared in the presence of KOH as catalyst by addition of propylene oxide using propane-1,2-diol as a starter.
Polyol 4 Polyether polyol having an OH number of 112 mg KOH/g prepared in the presence of KOH as catalyst by addition of propylene oxide using propane-1,2-diol as a starter.
Isocyanate 1 4,4′-methylenediphenyl diisocyanate, NCO content 33.6% by weight; 4,4′-methylenediphenyl diisocyanate >97% by weight; Desmodur® 44M (Covestro Deutschland AG)

The analyses were performed as follows:

Dynamic viscosity:

determined using an MCR 51 rheometer from Anton Paar according to DIN 53019.

NCO content:

determined according to DIN 53185.

OH number (hydroxyl number):

determined on the basis of DIN 53240-2 but using pyridine as the solvent instead of

THF/dichloromethane. It was titrated with 0.5 molar ethanolic KOH (endpoint detection by potentiometry). The reporting of the unit in “mg/g” relates to mg[KOH]/g[polyol].

Cold stability:

NCO prepolymers were stored in a cryostat at 20° C. The temperature was reduced by 2.5° C. after 24 h until crystal formation or precipitation of a solid was observed. The NCO prepolymers were considered cold-stable down to a temperature at which no crystal formation or solid precipitation was yet observed.

CO₂ proportion:

The proportion of incorporated CO₂ (“units deriving from carbon dioxide”; “CO₂ content”) in a polyether carbonate polyol may be determined from the evaluation of characteristic signals in the ¹H NMR spectrum. The following example illustrates the determination of the proportion of units deriving from carbon dioxide in a 1,8-octanediol-started CO₂/propylene oxide polyether carbonate polyol. Here, the CO₂ content describes the weight fraction of CO₂ based on the total polyether carbonate polyol.

The proportion of incorporated CO₂ in a polyether carbonate polyol and the ratio of propylene carbonate to polyether carbonate polyol may be determined by ¹H NMR (a suitable instrument is the DPX 400 instrument from Bruker, 400 MHz; pulse program zg30, delay time dl: 10 s, 64 scans). Each sample is dissolved in deuterated chloroform. The relevant resonances in the ¹H NMR (based on TMS=0 ppm) are as follows:

Cyclic propylene carbonate (formed as a by-product) having a resonance at 4.5 ppm, carbonate resulting from carbon dioxide incorporated in the polyether carbonate polyol having resonances at 5.1 to 4.8 ppm, unreacted propylene oxide (PO) having a resonance at 2.4 ppm, polyether polyol (i.e. without incorporated carbon dioxide) having resonances at 1.2 to 1.0 ppm, the octane-1,8-diol incorporated as starter molecule (if present) having a resonance at 1.6 to 1.52 ppm.

The weight fraction (in % by weight) of polymer-bonded carbon dioxide (LC′) in the reaction mixture was calculated by formula (I),

$${LC}^{′} = \frac{[ F ( 5.1 - 4.8 ) - F ( 4.5 ) ] * 102}{N} * 100 \% \qquad ( I )$$

wherein the value of N (“denominator” N) is calculated according to formula (II):

N═[F(5.1−4.8)−F(4.5)]*102+F(4.5)*102±F(2.4)*58+0.33*F(1.2−1.0)*58+0.25*F(1.6−1.52)*146 (II)

The following abbreviations are used here:

A(4.5)=area of the resonance at 4.5 ppm for cyclic carbonate (corresponds to one hydrogen atom)

A(5.1-4.8)=area of the resonance at 5.1 to 4.8 ppm for polyether carbonate polyol and an H atom for cyclic carbonate.

A(2.4)=area of the resonance at 2.4 ppm for free, unreacted PO

A(1.2-1.0)=area of the resonance at 1.2 to 1.0 ppm for polyether polyol

A(1.6-1.52)=area of the resonance at 1.6 to 1.52 ppm for octane-1,8-diol (starter), if present.

The factor of 102 results from the sum of the molar masses of CO₂ (molar mass 44 g/mol) and of propylene oxide (molar mass 58 g/mol), the factor of 58 results from the molar mass of propylene oxide, and the factor of 146 results from the molar mass of the octane-1,8-diol starter used (if present).

The weight fraction (in % by weight) of polymer-bonded carbon dioxide (LC′) may also be calculated from the mole fraction (mol %) LC of the polymer-bonded carbonate according to formula (III):

$${LC}^{′} = \frac{LC * 44}{LC * 102 + ( 100 - LC ) * 58} \qquad ( III )$$

Here too, the factors 44, 58 and 102 result from the molar masses of CO₂, propylene oxide and the sum of the molar masses of CO₂ and propylene oxide.

### Example 1

Preparation of the NCO Prepolymer Prep 1 According to the Invention:

In a 21 four-necked flask provided with a gas inlet, reflux condenser, stirrer and dropping funnel 722.8 g of isocyanate 1 (48.2 parts by weight) were initially charged under nitrogen and heated to 80° C. with stirring. A polyol mixture consisting of 777.2 g (51.8 parts by weight) of Polyol 1 were added to this solution such that the temperature did not exceed 80° C. Once addition was complete, the mixture was stirred at 80° C. for 2 h. The NCO content was then determined.

NCO content: 13.9% by weight

### Examples 2-4

The preparation of the NCO prepolymers Prep 2-4 was carried out analogously to the preparation of the NCO prepolymer Prep 1 in example 1 with the parts by weight reported in table 1.

TABLE 1
Preparation and cold stability tests of the NCO prepolymers;
examples not according to the invention: *

| | | Ex. 1 | Ex. 2 | Ex. 3* | Ex. 4* |
|---|---|---|---|---|---|
| | | Prep 1 | Prep 2 | Prep 3 | Prep 4 |
| Polyol 1 | [pts. by wt.] | 51.8 | — | — | — |
| Polyol 2 | [parts] | — | 46.6 | — | — |
| Polyol 3 | [parts] | — | — | 51.8 | — |
| Polyol 4 | [parts] | — | — | — | 46.6 |
| Isocyanate 1 | [parts] | 48.2 | 53.4 | 48.2 | 53.4 |
| NCO index | [—] | 745 | 458 | 745 | 458 |
| NCO content | [% by weight] | 13.9 | 13.8 | 13.8 | 13.8 |
| Dynamic | [mPa · s] | 4130 | 5560 | 950 | 2220 |
| viscosity, 25° C. | | | | | |
| Cold stability | [° C.] | 17.5 | 10 | 25 | 20 |

Since molecular mass has a direct influence on cold stability, prepolymer Prep 1 according to the invention is to be compared with prepolymer Prep 3 not according to the invention (OHN=56 mg KOH/g respectively) and prepolymer Prep 2 according to the invention is to be compared with Prep 4 not according to the invention (OHN=112 mg KOH/g respectively).

The NCO prepolymers according to the invention containing 4,4′-MDI and a polyether carbonate polyol (Examples 1-2) show improved cold stability. Comparative examples 3 and 4 show crystallization/formation of a solid already at higher temperatures.

The use of polyether carbonate polyols results in a cold stability for the NCO prepolymers that is improved by 7.5° C. or 10.0° C. compared to conventional NCO prepolymers based on polyether polyols.

1. A cold-stable NCO prepolymer obtainable from the reaction of
A) an isocyanate-reactive component comprising at least one polyether carbonate polyol obtainable from the reaction of a starter molecule with CO₂ and an alkylene oxide selected from the group consisting of ethylene oxide, propylene oxide and mixtures thereof; and
B) an isocyanate component comprising methylenediphenyl diisocyanate, the methylenediphenyl diisocyanate comprising a proportion of 4,4′-methylenediphenyl diisocyanate of at least 95% by weight based on the total amount of methylenediphenyl diisocyanate,
wherein the NCO prepolymer has an NCO content of 9-18% by weight;
wherein the polyether carbonate polyol has a CO₂ content of 5-25% by weight; and
wherein the polyether carbonate polyol comprises monomer units deriving from the CO₂ and from the alkylene oxide and at least 50%, respectively, of the monomer units deriving from the CO₂ and of the monomer units deriving from the alkylene oxide have a random distribution in the polyether carbonate polyol.

2. The cold-stable NCO prepolymer as claimed in claim 1, wherein the isocyanate component consists of the methylenediphenyl diisocyanate comprising a proportion of 4,4′-methylenediphenyl diisocyanate of at least 95% by weight based on the total amount of monomeric methylenediphenyl diisocyanate.

3. The cold-stable NCO prepolymer as claimed in claim 1, wherein the isocyanate-reactive component A) comprises a proportion of the at least one polyether carbonate polyol of at least 60% by weight based on the total isocyanate-reactive component A).

4. The cold-stable NCO prepolymer as claimed in claim 1, wherein the isocyanate-reactive component consists of the at least one polyether carbonate polyol.

5. The cold-stable NCO prepolymer as claimed in claim 1, wherein the polyether carbonate polyol has an OHN of 24-250 mg KOH/g.

6. The cold-stable NCO prepolymer as claimed in claim 1, wherein the polyether carbonate polyol has a CO₂ content of 7-22% by weight.

7. The cold-stable NCO prepolymer as claimed in claim 1, wherein the polyether carbonate polyol comprises two isocyanate-reactive groups.

8. The cold-stable NCO prepolymer as claimed in claim 1, wherein at least 75%, respectively, of the monomer units deriving from the CO₂ and of the monomer units deriving from the alkylene oxide have a random distribution in the polyether carbonate polyol.

9. A process for preparing a cold-stable NCO prepolymer having an NCO content of 9-18% by weight, the process comprising the steps of
i) providing an isocyanate-reactive component A) comprising at least one polyether carbonate polyol obtainable from the reaction of a starter molecule with CO₂ and an alkylene oxide selected from the group consisting of ethylene oxide, propylene oxide and mixtures thereof and an isocyanate component B) comprising methylenediphenyl diisocyanate comprising a proportion of 4,4′-methylenediphenyl diisocyanate of at least 95% by weight based on the total amount of methylenediphenyl diisocyanate,
ii) mixing components A) and B) to obtain a mixture, and
iii) reacting the mixture obtained in step ii) to obtain the cold-stable NCO prepolymer,
wherein the polyether carbonate polyol has a CO₂ content of 5-25% by weight and
wherein the polyether carbonate polyol comprises monomer units deriving from the CO₂ and from the alkylene oxide and at least 50%, respectively, of the monomer units deriving from the CO₂ and of the monomer units deriving from the alkylene oxide have a random distribution in the polyether carbonate polyol.

10. A method comprising preparing a polyurethane product with the cold-stable NCO prepolymer as claimed in claim 1.

11. A polyurethane elastomer, foam, adhesive or sealant obtainable from the reaction of the cold-stable NCO prepolymer as claimed in claim 1 with an isocyanate-reactive compound.

12. The polyurethane adhesive or sealant as claimed in claim 11, wherein the isocyanate-reactive compound is water from an environment of the cold-stable NCO prepolymer.

13. The cold-stable NCO prepolymer as claimed in claim 3, wherein the isocyanate-reactive component A) comprises a proportion of the at least one polyether carbonate polyol of at least 85% by weight based on the total isocyanate-reactive component A).

14. The cold-stable NCO prepolymer as claimed in claim 6, wherein the polyether carbonate polyol has a CO₂ content of 9-21% by weight.

15. The cold-stable NCO prepolymer as claimed in claim 8, wherein at least 95%, respectively, of the monomer units deriving from the CO₂ and of the monomer units deriving from the alkylene oxide have a random distribution in the polyether carbonate polyol.

16. The method as claimed in claim 10, wherein the polyurethane product is an elastomer, a foam, an adhesive or a sealant.

17. The polyurethane product as claimed in claim 11, wherein the polyurethane product is an elastomer, a foam, an adhesive or a sealant.

18. The polyurethane product as claimed in claim 12, wherein the environment of the cold-stable NCO prepolymer is a gas atmosphere surrounding the cold-stable NCO prepolymer. or a substrate on which the cold-stable NCO prepolymer is present

19. The polyurethane product as claimed in claim 12, wherein the environment of the cold-stable NCO prepolymer is a gas atmosphere surrounding a substrate on which the cold-stable NCO prepolymer is present.
